(19) United States
(12) Patent Application Publication
(10) Pub. No.: US 2026/0104264 A1
(43) Pub. Date: Apr. 16, 2026

(54) ESTIMATION METHOD OF DRIVING TIME ON STOPOVER ROUTE AND DEVICE FOR IMPLEMENTING SAME

(71) Applicants: Hyundai Motor Company, Seoul (KR); Kia Corporation, Seoul (KR)

(72) Inventor: Nam Hyuk Kim, Hwaseong-si (KR)

(21) Appl. No.: 19/331,659

(22) Filed: Sep. 17, 2025

(30) Foreign Application Priority Data
Oct. 10, 2024 (KR) 10-2024-0137647

(51) Int. Cl. G01C 21/36; G06N 3/0455

(52) U.S. Cl. CPC G01C 21/3617; G01C 21/3679; G06N 3/0455

(57) ABSTRACT

A method of estimating a driving time of a vehicle on a stopover route is carried out by a memory that stores instructions and a processor that executes the instructions. An electronic device is configured to implement the estimation method. The method includes predicting an estimated arrival time of the stopover, in response to a route request of the vehicle including the stopover; estimating a stay time of the stopover based on user information of the vehicle and scheduled use information of the stopover; and predicting a final driving time to a destination based on the estimated stay time.

### CROSS-REFERENCE TO RELATED APPLICATION

This application claims under 35 U.S.C. § 119(a) the benefit of Korean Patent Application No. 10-2024-0137647 filed on Oct. 10, 2024, the entire contents of which are incorporated herein by reference.

### BACKGROUND

### (a) Technical Field

The present disclosure relates to an estimation method of a driving time on a stopover route and a device for implementing the same, more particularly, to the method and device for estimating driving time that accurately predicts an estimated arrival time to a destination as guidance for a route including a stopover.

### (b) Description of the Related Art

An electronic device may be equipped with navigation functionality (e.g., GPS) that provides a route on a map to a destination desired by the user. Here, the electronic device may be a portable device such as a smart phone, but is not limited thereto, and may be a tablet or other electronic device having software functions similar to those of a portable device and manufactured in various forms. The product may be a means of transportation, for example a vehicle.

The navigation may process a route guidance request, including a stopover to visit while driving to the final destination, for user convenience. Conventional route guidance is processed based on the assumption that after reaching a stopover, the vehicle drives to a destination immediately without staying at the stopover. Such a stopover may be a point of interest at a location specified by the user's intent. The user who has requested a stopover is actually destined for a destination after staying for a period of time. According to the conventional route guidance, the stay of the stopover is not considered, and the driving time of the route including the stopover is inaccurate, so that the user may not know the exact estimated arrival time of the destination.

Moreover, even with the same stopover, the stay time of the stopover may be different depending on the characteristics of the vehicle user and the user-specific driving situation. Accordingly, when predicting the final driving time of a route including a stopover, the navigation needs to provide a personalized stay time in consideration of the characteristics and driving situation of the user.

### SUMMARY

The present disclosure is directed to providing a method and a device for estimating driving time that accurately predict an estimated arrival time to a destination as guidance for a route including a stopover.

The technical problems to be solved in the present disclosure are not limited to the above-mentioned technical problems, and other technical problems that are not mentioned will be clearly understood by those skilled in the art in the technical field to which the present disclosure belongs from the following description. According to the present disclosure, a method for estimating a driving time on a stopover route includes steps of: providing a memory configured to store at least one instruction and a processor configured to execute the at least one instruction stored in the memory; predicting, by the processor, an estimated arrival time of a stopover, in response to a route request of a vehicle including the stopover; estimating, by the processor, a stay time of the stopover based on user information of the vehicle and scheduled use information of the stopover; and predicting, by the processor, a final driving time to a destination based on the estimated stay time.

According to one aspect, there is provided a method comprising: predicting an estimated arrival time of a stopover, in response to a route request of a vehicle including the stopover; estimating a stay time of the stopover based on user information of the vehicle and scheduled use information of the stopover; and predicting a final driving time to a destination based on the estimated stay time.

According to the method, the user information may comprise user attribute data and driving data, the user attribute data includes at least one of an age and a gender of the user, and the driving data includes a distance to the stopover.

According to the method, the scheduled use information may comprise stopover data, an estimated time zone in which the stopover is used, and a date characteristic associated with a use date of the stopover, the stopover data may include an identifier of the stopover, a type of the stopover, and operation data of the stopover, and the estimated time zone may be determined based on the estimated arrival time.

According to the method, the date characteristic may be defined as any one of weekdays, weekends, and holidays.

According to the method, the estimating a stay time of the stopover may comprise estimating the stay time using a deep learning-based stay time estimation model.

According to the method, the stay time estimation model may use a convolutional neural network-based autoencoder model.

According to the method, the estimated stay time may be an average stay time according to analysis of the user information and the scheduled use information.

According to the method, the estimated stay time may be generated to be equal to or longer than a minimum stay time according to the analysis of the user information and the scheduled use information.

According to the method, the stay time used for learning of the stay time estimation model may be generated based on time data of previous driving trajectory data of visiting the stopover, and the time data may include an arrival time of the stopover and a departure time of the stopover.

According to the method, the stay time used for learning of the stay time estimation model may use a stopover stay time accumulated with the previous stopover use, and may be generated as a weighted average of the accumulated stopover stay time, and the weighted average may give a lower weight to a stopover stay time collected relatively in the past.

According to the present disclosure, an electronic device includes: a communication unit for transmitting and receiving data to and from the external device; a memory configured to store at least one instruction; and a processor configured to execute the at least one instruction stored in the memory, wherein the processor is configured to: predict an estimated arrival time of a stopover, in response to a route request of a vehicle including the stopover; estimate a stay time of the stopover based on user information of the vehicle and scheduled use information of the stopover; and predict a final driving time to a destination based on the estimated stay time.

According to another aspect, there is provided an electronic device for estimating a driving time on a stopover route, the electronic device comprising: a communication unit for transmitting and receiving data to and from an external device; a memory for storing at least one instruction; and a processor for executing the at least one instruction stored in the memory. The processor is configured to: predict an estimated arrival time of a stopover, in response to a route request of a vehicle including the stopover; estimate a stay time of the stopover based on user information of the vehicle and scheduled use information of the stopover; and predict a final driving time to a destination based on the estimated stay time.

According to the present disclosure, a non-transitory computer readable medium containing program instructions executed by a processor includes: program instructions that predict an estimated arrival time of a stopover, in response to a route request of a vehicle including the stopover; program instructions that estimate a stay time of the stopover based on user information of the vehicle and scheduled use information of the stop; and program instructions that predict a final driving time to a destination based on the estimated stay time.

The features briefly summarized above for this disclosure are only exemplary aspects of the detailed description of the disclosure which follow, and are not intended to limit the scope of the disclosure.

The technical problems solved by the present disclosure are not limited to the above technical problems and other technical problems which are not described herein will be clearly understood by a person (hereinafter referred to as an ordinary technician) having ordinary skill in the technical field, to which the present disclosure belongs, from the following description.

### BRIEF DESCRIPTION OF THE DRAWINGS

FIG. 1 is a diagram illustrating that a vehicle communicates with another device to transmit and receive data.

FIG. 2 is a diagram illustrating a module constituting a vehicle.

FIG. 3 is a diagram illustrating modules constituting an electronic device according to an embodiment of the present disclosure.

FIG. 4 is a diagram schematically illustrating a model for estimating the final driving time.

FIG. 5 is a diagram illustratively showing the structure of the stay time estimation model.

FIGS. 6A-6B are diagrams illustratively showing data used in the stay time estimation model.

FIG. 7 is a diagram illustrating an actual stay time.

FIG. 8 is a flowchart of a driving time estimation method according to another embodiment of the present disclosure.

FIG. 9 is a diagram comparing the estimation of the driving time according to the conventional method and the present embodiment.

### DETAILED DESCRIPTION OF EXEMPLARY EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, exemplary embodiments of the present disclosure will be described in detail with reference to the accompanying drawings so that those skilled in the art may easily implement the present disclosure. However, the present disclosure may be implemented in various different ways, and is not limited to the embodiments described therein.

In describing exemplary embodiments of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween.

In the present disclosure, the terms first, second, etc. are only used to distinguish one element from another and do not limit the order or the degree of importance between the elements unless specifically mentioned. Accordingly, a first element in an embodiment could be termed a second element in another embodiment, and, similarly, a second element in an embodiment could be termed a first element in another embodiment, without departing from the scope of the present disclosure.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of them may be optional elements. Therefore, an embodiment composed of a subset of elements described in an embodiment is also included in the scope of the present disclosure. In addition, embodiments including other elements in addition to the elements described in the various embodiments are also included in the scope of the present disclosure.

The advantages and features of the present disclosure and the way of attaining them will become apparent with reference to embodiments described below in detail in conjunction with the accompanying drawings. Embodiments, however, may be embodied in many different forms and should not be constructed as being limited to example embodiments set forth herein. Rather, these embodiments are provided so that this disclosure will be complete and will fully convey the scope of the disclosure to those skilled in the art.

In the present disclosure, each of phrases such as “A or B”, “at least one of A and B”, “at least one of A or B”, “A, B or C”, “at least one of A, B and C”, “”at Each of the phrases such as “at least one of A, B or C” and “at least one of A, B, C or combination thereof” may include any one or all possible combinations of the items listed together in the corresponding one of the phrases.

In the present disclosure, expressions of location relations used in the present specification such as “upper”, “lower”, “left” and “right” are employed for the convenience of explanation, and in case drawings illustrated in the present specification are inversed, the location relations described in the specification may be inversely understood.

Hereinafter, embodiments of the present disclosure will be described with reference to the accompanying drawings.

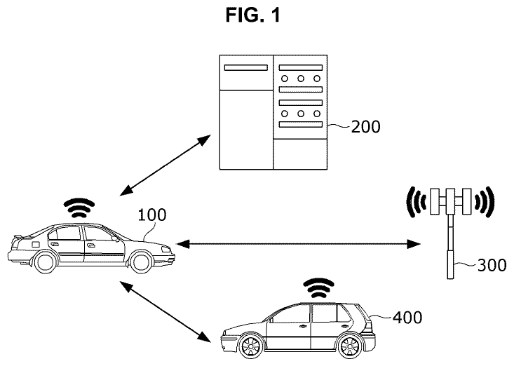

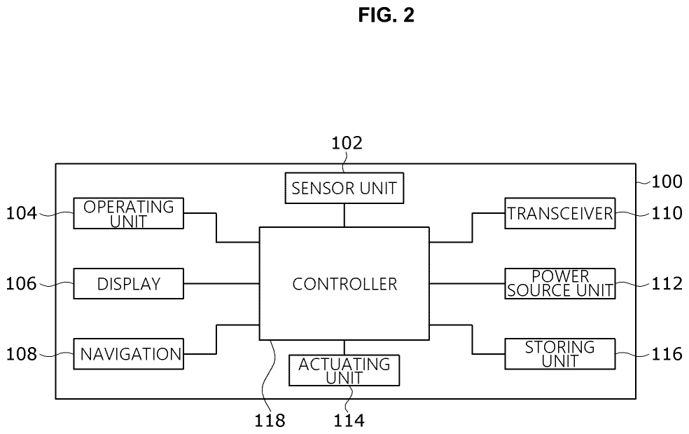

Hereinafter, an electronic device and a vehicle for estimating a driving time on a stopover route will be described with reference to FIGS. 1 and 2. FIG. 1 is a diagram illustrating that a vehicle communicates with another device to transmit and receive data. FIG. 2 is a diagram illustrating a module constituting a vehicle.

In the present disclosure, an example in which an electronic device processes a route request received from a vehicle 100 is described. The electronic device may be, for example, a server 200 implementing a navigation function that processes requests of the vehicle 100 while communicating with the vehicle 100. Unlike the example described above, the electronic device communicates with another kind of electronic device in addition to the vehicle, and an electronic device such as a portable terminal (e.g., a smartphone) may deliver the route request to the electronic device 200. The electronic device may process the request of the mobile terminal. Accordingly, the following matters are mainly described with reference to the use request processing between the vehicle 100 and the electronic device (server; 200), but may be substantially similarly applied to the mobile terminal.

Referring to FIG. 1, the vehicle 100 may be driven based on an electrical energy or fossil energy. In the case of electrical energy, the vehicle 100 may, for example, employ a purely battery-based vehicle driven solely by a high-voltage battery or a gas-based fuel cell as the energy source. Further, the fuel cell may utilize various forms of gas capable of generating electrical energy, and the gas may be filled into the vehicle 100 in a liquefied state, for example. Here, the gas may be hydrogen, for example. However, it is not limited to this and various gases are applied. In the case of fossil energy, the vehicle 100 may be equipped with an internal combustion engine that is driven based on a fuel, such as gasoline, diesel, or liquefied gas, and that drives an actuating unit 114 by combustion of the fuel. As another example, the vehicle 100 may selectively utilize the energy of a fossil energy-based internal combustion engine and an electric battery to drive the actuating unit 114, which may be a hybrid type of vehicle.

The vehicle 100 may refer to a device that may move. The vehicle 100 is a ground vehicle driving on the ground, and may be a conventional passenger or commercial vehicle, a purpose built vehicle (PBV), or the like. The vehicle 100 may be a four-wheeled vehicle, such as a passenger car, an SUV, a small truck, or may be a vehicle with more than four wheels, such as a bus, a large truck, a container carrying vehicle, a heavy-duty vehicle, or the like. The vehicle 100 may be a robot in its broadest sense, such as a moving means, and the robot may be moved using wheels, tracks, or other moving modules. The vehicle 100 may be controlled and driven through autonomous driving, and the autonomous driving may be implemented as semi-autonomous driving or fully autonomous driving.

Meanwhile, the vehicle 100 may perform communication with another device 200, 300 or another vehicle 400. Other devices may include, for example, a server 200 that supports various controls, state management, and driving of the vehicle 100, an intelligent transportation system (ITS) device 300 for receiving information from the ITS, various types of user devices, and the like. The server 200 is, for example, an external device operated by a vehicle manufacturer or provided for servicing autonomous driving, and may receive connected data of the vehicle 100 or transmit data necessary for autonomous driving. The server 200 may transmit various information and software modules used for control of the vehicle 100 to the vehicle 100 in response to a request and data transmitted from the vehicle 100 and a user device, so as to support driving and various services of the vehicle 100.

The server 200 may process and provide a route request requested by the vehicle 100 to the vehicle 100. Here, the user may request a route including a destination and a stopover. The stopover may be a location to be visited by a user of the vehicle 100 while driving to a destination. In the present disclosure, the stopover may be referred to herein as a point of interest because the stopover is a point where a user intentionally visits and utilizes a service provided by the stopover. In the present disclosure, stopover and point of interest may be described interchangeably.

The stopover and the destination may be a place designated by the user by inputting a specific name in the navigation unit 108, or a place output as having a relationship with a rough term by inputting the rough term in the navigation unit 108. The specific name is a unique name of a spot or a specific location, and may be, for example, an AA restaurant, a BB resort, a CC intersection, a DD avenue, or the like. The rough term may be, for example, a service term or category that the user desires to use, and the like, and may be inputted to, for example, restaurants, cafes, attractions in a specific region, and the like. When the user searches for an interest in a rough term, the user may input a service term or category to be used at the current location or another location into the navigation unit 108.

The ITS device 300 is, for example, a roadside base station (road side unit; RSU), and the ITS device 300 may interchange vehicle recognition data, driving control and state data, environmental data around the vehicle, and the like via V2I with the vehicle 100, to assist the user in driving the own vehicle or support autonomous driving of the vehicle 100. The vehicle 100 may interchange the above-listed data via V2V with the other vehicle 400 to support manual driving or autonomous driving.

The vehicle 100 may communicate with other vehicles or other devices based on cellular communication, wireless access in vehicular environment (WAVE) communication, dedicated short range communication (DSRC) or near field communication, or other communication schemes.

For example, the vehicle 100 may use a communication network such as LTE or 5G, a WiFi communication network, a WAVE communication network, or the like as a cellular communication network for communication with the server 200, the ITS device 300, and the other vehicle 400. As another example, a DSRC or the like used in the vehicle 100 may be used for communication between vehicles. A communication manner between the vehicle 100, the server 200, the ITS device 300, the another vehicle 400, and the user device is not limited to the foregoing embodiment.

FIG. 2 is a diagram illustrating a module constituting a vehicle according to an embodiment of the present disclosure.

The vehicle 100 may include a sensor unit 102, an operating unit 104, a display 106, a navigation unit 108, and a transceiver 110.

The sensor unit 102 may include various types of detectors for sensing various conditions and situations occurring in an external environment, an internal system, a user operation, and a boarding space of the vehicle 100. The sensor unit 102 may include an externally-oriented camera, a lidar sensor, a radar sensor, or the like to recognize dynamic and static objects existing outside the vehicle 100. The sensor unit 102 may include a positioning sensor, a wheel sensor, a posture sensor, and the like in order to check its own position, speed, driving posture, and the like. The sensor unit 102 may further include a sensing module that senses various situations not listed here.

The operating unit 104 may be configured as a module for a user to navigate for driving. For example, the operating unit 104 may be a steering wheel for manual driving, an automatic or manual transmission actuator, an accelerator pedal, a brake pedal, a transmission, or the like. The operating unit 104 may further include an interface for use, release, and selection of detailed functions of the autonomous driving mode requested by the user, so that the user uses the autonomous driving function.

The display 106 may serve as a user interface. The display 106 may be displayed by a controller 118 to output an operating state of the vehicle 100, a control state, route/traffic information, remaining energy information, content requested by the driver, and the like. In addition, the display 106 may be configured as a touch screen on which driver input is detectable to receive a request from the driver instructing the controller 118.

The navigation unit 108 may receive a route request related to a stopover and a destination from a user and transmit the route request to the server 200, and may receive driving trajectory data according to a route and an expected driving time of each point from the server 200. The driving trajectory data may be displayed on a map provided by the navigation unit 108. In the present disclosure, the expected driving time of the destination may be described in combination with the final driving time, and the expected driving time of the stopover may be described in conjunction with the scheduled arrival time of the stopover. The navigation unit 108 may be implemented in the display 106 or may be implemented in a separate device mounted on the vehicle 100. The separate device may be, for example, a module uniquely installed in the vehicle 100 or an electronic device of a user connected to the vehicle 100 in a wired or wireless manner. The user's electronic device may be controlled to connect with the vehicle 100 to present the route request, route information, and congestion information to an output interface, such as the display 106.

Although the present disclosure mainly describes the module according to the present embodiment in FIG. 2, the vehicle 100 may further include a load device in addition to the navigation unit 108. The load device may be a type of non-driving electric device other than a driving power system such as a wheel driving unit (not shown). The load device is an auxiliary device that receives power from a power source unit 112, and may be, for example, an air conditioning system, a lighting system, a seat system, various devices installed in the vehicle 100, or the like.

The transceiver 110 support mutual communication with the server 200, the ITS device 300, surrounding vehicles 400 and the like. The transceiver 110 may include, for example, a module that processes cellular communication, WAVE, DSRC communication, and the like. The transceiver 110 may support communication with an electronic device carried by an occupant inside the vehicle 100.

The vehicle 100 may also include a power source unit 112 and an actuating unit 114.

The power source unit 112 may generate and supply power and electric power to be used for the driving power system and the non-driving power system, such as the actuating unit 114. The non-driving power system may be, for example, the sensor unit 102, the operating unit 104, the display 106, the load device, the transceiver 110, and the like. When the vehicle 100 is driven based on electrical energy, the power source unit 112 may consist, for example, of an electrical battery which is charged from the outside, or of a combination of an electrical battery and a fuel cell which charges the battery. When the vehicle 100 is driven based on a fossil energy, the power source unit 112 may be configured as an internal combustion engine. Further, when the vehicle 100 is of a hybrid type, the power source unit 112 may be provided by a combination of an internal combustion engine and an electric battery.

The actuating unit 114 includes at least one module that implements a driving operation, and may perform at least one driving operation of a longitudinal control such as acceleration and deceleration and a lateral control such as steering according to a user request from the operating unit 104. To this end, the actuating unit 114 may include a plurality of wheels, a driving force generation module for generating a driving force to provide the driving force to the wheels or transmitting the driving force, a braking module for decelerating driving of the wheels, a steering module for realizing lateral control of the wheels and the like. When the vehicle 100 is driven based on electric energy, the driving force generation module is configured as a motor assembly, and the braking module may further have a regenerative braking function.

The vehicle 100 may also include a storing unit 116 and a controller 118.

The storing unit 116 may store applications and various data for control of vehicle 100 to load applications, read data, or record data at the request of controller 118. In the present disclosure, the storing unit 116 may hold a software module for processing route guidance, for example, a navigation application.

The controller 118 may perform overall control of the vehicle 100. The controller 118 may be configured to execute applications and instructions stored in the storing unit 116. The controller 118 may execute a navigation application to process the user's request. Specifically, the controller 118 may receive a route request input by a user of the vehicle 100, transmit the route request to the server 200, and provide a response from the server 200 that processes the request to the user.

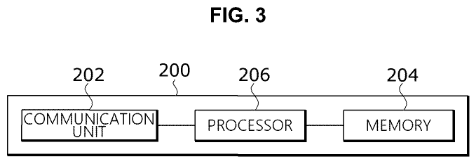

FIG. 3 is a diagram illustrating modules constituting an electronic device according to an embodiment of the present disclosure. An electronic device executing a request for a route including a stopover in the present disclosure may be illustrated as a server 200 in communication with the vehicle 100.

The server 200 may perform a navigation function of providing various service functions, as well as guiding a driving trajectory including a stopover and a destination and a final driving time, in response to a route request of the vehicle 100, as described above. The server 200 may include a communication unit 202, a memory 204, and a processor 206.

The communication unit 202 transmits and receives data to and from an external device, supports mutual communication with the vehicle 100 in the present disclosure, and may exchange data with the vehicle 100.

The memory 204 may store an application for operating the server 200 and various data, so as to load the application or read and record data at the request of the processor 206. In the present disclosure, the memory 204 may hold a software module, for example a navigation application, for processing a request, such as a route request, received from the vehicle 100. The memory 204 may manage various information for the processing of route requests. The managed information may include, for example, map information, user information of the vehicle 100, spot information associated with a stopover, and data for training a model that estimates a final driving time and a stay time.

As provided herein, the term “stay time” refers to a length of time that a vehicle remains at a stopover location along a route, and according to the disclosure, may be estimated based on user information of the vehicle and scheduled use information of the stopover.

The user information may include user attribute data and driving data. The user attribute data may include, for example, at least one of an age and a gender of a current user of the vehicle 100. Without being limited thereto, the user attribute data may have various data identifying characteristics of the user. The driving data may include a distance to the stopover calculated based on a request for a route including the stopover. The driving data may include, in addition to the distance, driving trajectory data to a route destination based on a traffic condition, a scheduled arrival time of a stopover, event information on the stopover route, and the like. The server 200 includes the driving data in the route information of the destination in response to the route request, and the route information having the driving data may be transmitted to the vehicle 100.

The user attribute data of the user information may be transmitted from the vehicle 100 in conjunction with receipt of the route request. The user may command the transmission of the user attribute data while requesting a route through the vehicle 100 and the user device. For example, the user may select a user identifier provided by the navigation unit 108 or the user device, thereby transmitting user attribute data corresponding to the user identifier to the server 200. The user identifier may be a user profile or user identification ID that is intuitively verifiable by the user. Alternatively, when the primary user of the vehicle 100 is designated, the controller 118 of the vehicle 100 may send the user attribute data associated with the primary user to the server 200, along with the route request, by setting, even when the user does not request the transmission of the user attribute data.

In another example, the user attribute data may be stored on the server 200. By the user selecting a user identifier at the navigation unit 108 or user device, the identifier may be transmitted to the server 200 along with the route request. The server 200 may select user attribute data matching the user identification information.

The spot information may, for example, have at least one of an identifier of the point, a type of the point, operational data of the point, provision items of the stopover, a size of the point, or a customer acceptance range of the point. The type of point may be a type of function or service unique to the stopover. For example, the types may be distinguished as functions or services of restaurants, tourist attractions, cafes, streets, amenities/entertainment facilities, and the like. The operating data of the spot may include, for example, business hours of the spot, availability of reservations, presence or absence of a parking lot, and the like. The provision item of the point may be a detailed menu constituting the service. For example, the item may include a menu of a restaurant/caffeine, various menus provided by amenities or entertainment facilities. The size of the point may include, for example, the size of the facility in question, the rotation rate of the customer using the point, etc. The customer acceptance range of the spot may include, for example, a maximum number of visitors, a number of seats, a maximum number to wait, and the like of the spot.

Details of the data for training the model are described below.

The processor 206 may perform overall control of the server 200. The server 200 may be configured to execute applications and instructions stored in the memory 204. The processor 206 may execute the navigation application to process and respond to the user's request sent from the vehicle 100. In connection with the disclosure, the processor 206 may perform processing of predicting an expected arrival time of a stopover in response to a route request of a vehicle including the stopover. Further, the processor 206 may execute a process of estimating the stay time at the stopover based on user information of the vehicle 100 and scheduled use information of the stopover. The processor 206 may perform processing to predict a final driving time to a destination based on the estimated stay time.

In the present disclosure, the processor 206 consists of a single processing module. In another example, the processor 206 may be distributed to a plurality of processing modules, and the above processing may be executed by a distributed processing model.

Meanwhile, the model for estimating the final driving time is embedded in the memory 204 and may be loaded by the route request and executed in the processor 206. The processor 206 may transmit the final driving time of the destination along the route including the stopover by the model to the vehicle 100. The estimation model of the final driving time is executed in a navigation application, and the navigation application generates driving trajectory data including, but not limited to, a stopover and a destination and event information on a route. The navigation application may transmit the driving trajectory data and the event information to the vehicle 100, along with the final driving time.

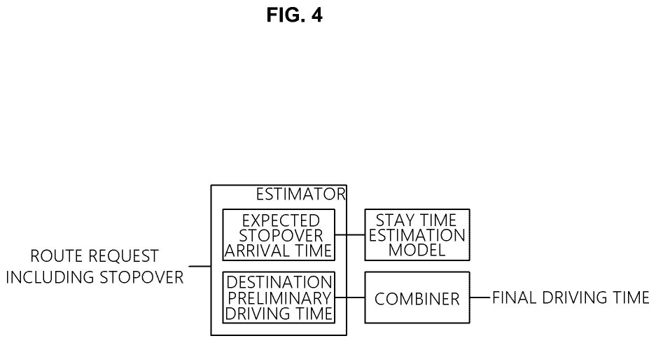

The estimation model of the final driving time may include a stay time estimation model that takes into account the visit of the stopover, as illustrated in FIG. 4. FIG. 4 is a diagram schematically illustrating a model for estimating the final driving time.

Specifically, the estimation model of the final driving time may include an estimator, a stay time estimation model, and a combiner.

The estimator may, in response to the route request including the stopover, generate an expected arrival time of the stopover based on driving trajectory of the stopover. The driving trajectory of the stopover is provided by the navigation application and may be generated based on, for example, a traffic condition, a distance to the stopover. The generated driving trajectory may be transmitted to the estimator.

The estimator may generate a preliminary driving time of the destination based on the driving trajectory of driving through the stopover to the destination without staying. The preliminary driving time may be a scheduled arrival time of the destination according to the non-stopover passing of the stopover. The driving trajectory of the destination may be generated by the navigation application. The driving trajectory of the destination may be generated, for example, on the basis of the overall distance via the stopover, the traffic situation at the time of departure and the time of stopover through the stopover. The estimator described above may be built with a machine learning model or a rule-based model. Additionally, in navigation, the driving trajectory data may also be generated by a machine learning model or a rule-based model.

The stay time estimation model may estimate the stay time at the stopover based on the user information of the vehicle 100 and the scheduled use information of the stopover. That is, the stay time estimation model may generate the stay time as output data by using the user information and the scheduled use information as input data. The user information is the same as that described above, and a detailed description thereof is omitted.

The scheduled use information may include detailed data of the stopover used by the user and various data related to the scheduled use time of the user for the stopover. The scheduled use information may include, for example, stopover data, an estimated time zone to use the stopover, and date characteristics associated with the date of use of the stopover.

The stopover data may include an identifier of the stopover, a type of the stopover, and operational data of the stopover. The stopover data may be obtained using point information matching the stopover specified by the route request. The vehicle 100 may transmit the stopover identifier to the server 200, so that the server 200 may identify an identifier of a point matching the transmitted stopover identifier. The stopover identifier may use the specific name of the stopover entered by the user without further processing. The type of stopover and the operating data may be acquired through the type of point and the operating data of the point matching the identifiers.

The estimated time zone may be a time at which the user is estimated to arrive at the stopover and be available for service of the stopover. The estimated time zone may be determined based on the estimated arrival time of the stopover generated from the estimator. The date characteristic may indicate a type of visit date of the stopover. For example, the date characteristic is defined as any one of weekdays, weekends, and holidays, and may be defined in various ways.

The combiner may sum the estimated stay time of the stopover and the preliminary driving time to the destination to generate a final driving time of the destination reflecting the stay of the stopover.

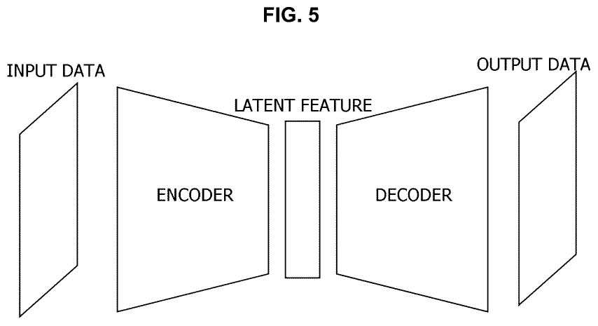

The stay time estimation model will be described in detail with reference to FIG. 5. FIG. 5 is a diagram illustratively showing the structure of the stay time estimation model.

The stay time estimation model may use a deep learning-based learning model. As shown in FIG. 5, the stay time estimation model may be configured as an autoencoder model based on a convolutional neural network. In the present disclosure, the model is exemplified as one type of convolutional neural network described below, but may be constructed by various types of deep learning models.

The estimation model may include an encoder that outputs a potential feature (hereinafter abbreviated as a feature) of input data based on the input data, and a decoder that infers a stay time based on the feature. The encoder and decoder may be configured to include a plurality of layers of various kinds. The encoder may be configured to have a convolution layer, a filter (or kernel) and pooling layer, for example. The decoder may, for example, be configured with a deconvolution layer and an upsampling layer.

The input data may be processed to suit the input format of the encoder. The user information and the scheduled use information may be processed into encoder-recognizable multi-dimensional data.

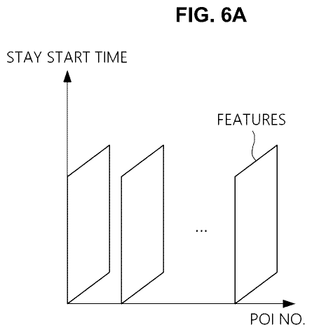

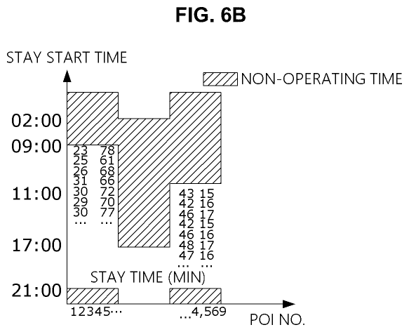

FIGS. 6A-6B are diagrams illustratively showing data used in the stay time estimation model. The encoder may generate features defined for various pieces of detailed data belonging to the user information and the scheduled use information, as illustrated in FIG. 6A. POI shown in FIGS. 6A and 6B means a place of interest, and hereinafter may be understood substantially the same as a place of stopover. POI number may be a number identifying each stopover.

The output data may be, for example, an estimated stay time for a predetermined period of time at the stopover requested by the user. As another example, the output data may be the estimated stay time for each time period of all stops managed by the server 200, as in FIG. 6B. Here, the estimated stay time may be output as the stay time of the stopover matching the user information of the route-requesting user. The estimation model may output, through a decoder or subsequent processing, only the stay time corresponding to the stopover of the user from among the estimated stay times of the entire stopover.

The stay time estimation model may be trained using actual stay time of the stopover and learning input data corresponding to the input data.

The learning input data may include user information of a plurality of users who have visited the route of the vehicle 100 by requesting a stopover and use information of the plurality of stopovers. The user attribute data of the user information may include at least one of an age and a gender of the user. The driving data of the user information may include a distance from the departure point to the stopover. The use information of the stopover may have data similar to the scheduled use information. The use information may include point information of a plurality of stopovers visited by a plurality of users, a visiting time zone of each stopover, and a visiting date characteristic of each stopover. The point information includes point data corresponding to the stopover, for example, an identifier, a type, operation data, and may further have other data belonging to the point information.

The actual stay time of the stopover may be used as ground truth data for the learning of the estimation model. Here, the stopover described in the description of the ground truth data may include not only an intermediate destination on the stopover route, but also a final destination that goes straight without an intermediate stopover. The final destination may be a point of interest associated with a point that provides a particular service to the user. In the present disclosure, for the convenience of description, a stopover is used in the same sense as an interest, which is used in a sense including an intermediate destination and a final destination, and these terms may be used interchangeably.

The ground truth data may be provided as the actual stay time of the vehicle for each of the plurality of stops visited by the plurality of users, as illustrated in FIG. 6B. The actual stay time may be obtained using previous driving trajectory data for each stopover visited by the plurality of users. The previous driving trajectory data may correspond to previous driving data of the vehicle used by the user. That is, the actual stay time of the user may be an actual stay time of a vehicle that is calculated for each stopover. The actual stay time may be generated based on time data of previous driving trajectory data at each stopover collected for the plurality of vehicles. Here, the time data may include an arrival time of the stopover and a departure time of the stopover. The actual stay time may be a time during which each user stays in the use time zone of each stopover.

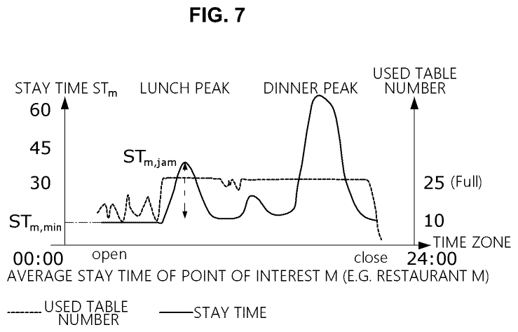

Describing the collection of the actual stay time in detail with the example of FIG. 7, the actual stay time may be generated based on the driving trajectory data of the vehicle for each use time period in the interest point m corresponding to a specific stopover. The actual stay time may be calculated as an average of the stay time of the vehicle at the interest point m. In addition, the actual stay time may be calculated as an average with respect to the accumulation of the actual stay time belonging to the time section so as to easily check the actual stay time for each time section and reduce the computation resource of the output data. Accordingly, the estimated stay time output from the estimation model may be provided as an average stay time according to the analysis of the user information and the scheduled use information.

In addition, the actual stay time may be generated based on hourly stay times collected over a period of time. The average for the actual stay time may be calculated by assigning higher weights to the latest collected stay time by time zone and assigning lower weights to to the stay time by past time zone. That is, the actual stay time uses the interest stay time of the vehicle that is accumulated with previous stopover use, and may be generated as a weighted average of the accumulated interest stay time. The weighted average may give a relatively low weight to past-collected stopover times. Here, the interest use may have the same meaning as the stopover use, and the interest stay time may also be referred to as a stopover stay time.

The actual stay time of the interest point m is, as in FIG. 7, a sum of a minimum stay time (STₘᵢₙ) and an addition stay time (STⱼₐₘ). The additional stay time may be a congestion stay time. The minimum stay time may be set for each stopover according to analysis of the user information and the use information. Accordingly, the estimation model does not output an excessively low and substantially invalid stay time, and may output a stay time equal to or longer than the valid minimum stay time. That is, the stay time output from the estimation model may be generated to be equal to or longer than the minimum stay time according to the analysis of the user information and the scheduled use information.

The server 200 may use the learning demand data and the actual stay time to train the learnable parameters, i.e., weights, that make up the stay time estimation model illustrated in FIG. 5. The estimation model may be trained until a loss function between the estimated stay time and the actual stay time is less than or equal to a predetermined value, or the variation in the value of the loss function converges to a predetermined range. The loss function uses, for example, but not limited to, mean squared error.

The stay time estimation model is trained according to the foregoing, so that the server 200 may estimate the stay time of the stopover associated with the stopover route request by using the estimation model. Hereinafter, the congestion estimation processing of the server 200 including the processor 206 described above will be described in detail with reference to FIGS. 1 to 8.

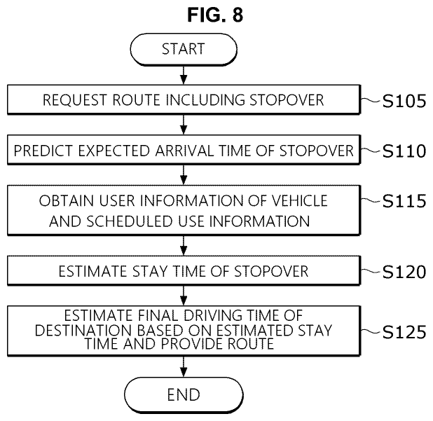

FIG. 8 is a flowchart of a driving time estimation method according to another embodiment of the present disclosure.

In the present disclosure, an electronic device that requests guidance of a route including a stopover is illustrated as vehicle 100, and an electronic device that processes the request is illustrated as server 200. However, the present disclosure is also substantially applicable to an embodiment in which the electronic device is a portable terminal of a user. In addition, the embodiments of the present disclosure may also be applied to an embodiment in which a model embedded in the server 200 is transmitted to the vehicle 100 or a mobile terminal of a user, and the vehicle 100 or the mobile terminal generates driving trajectory data to a destination and estimates a final driving time of the destination by using the model, as long as there is no technical contradiction. Meanwhile, for convenience of description, the processor 206 and the controller 118 may be described interchangeably with the server 200 and the vehicle 100, respectively.

First, the user may request, via the navigation unit 108 of the vehicle 100, a route including a stopover and a destination, and transmit the route to the server 200 (S105).

The user may input both a stopover and a destination in the navigation unit 108. Details of the entry of stopovers and destinations are detailed in FIG. 3.

Next, the processor 206 of the server 200 may predict an scheduled arrival time of the stopover (S110).

The processor 206 may estimate the scheduled arrival time using the estimator shown in FIG. 4. For example, the processor 206 may generate the scheduled arrival time of the stopover and the driving trajectory data to the stopover based on the time at the time of the request and the expected traffic condition to the stopover. The driving trajectory data may be generated by a navigation application driven by the processor 206.

Next, the processor 206 of the server 200 may obtain user information of the vehicle user and scheduled use information of the stopover (S115).

The user information may include user attribute data and driving data. The user attribute data may have at least one of an age and a gender of the user. The user attribute data may be received, for example, from the vehicle 100. The driving data includes, but is not limited to, the distance from the departure point to the stopover, and may further have the above-described data. The driving data may be obtained from the driving trajectory data of the stopover described in step S110.

The scheduled use information may include stopover data, an expected time zone to use the stopover, and a date characteristic associated with the date of use of the stopover. The stopover data may be received from the vehicle 100 where the user inputs a stopover. The expected time zone is determined based on the scheduled arrival time, and the date characteristic may be any one of weekdays, weekends, and holidays. Other details are the same as described above.

Next, the processor 206 of the server 200 may estimate the stay time of the stopover based on the user information and the scheduled use information (S120).

The stay time of the stopover may be estimated by a deep learning-based stay time estimation model. The stay time estimation model may be a convolutional neural network based autoencoder model illustrated in FIG. 5. The estimated stay time may be an average stay time according to the analysis of the user information and the scheduled use information. Further, the estimated stay time may be generated to be equal to or greater than a minimum stay time according to the analysis of the user information and the scheduled use information. Other structures and operations of the estimation model are not described in FIG. 5.

Next, the processor 206 may predict a final driving time to the destination based on the estimated stay time, and transmit route information to the destination to the vehicle 100 (S125).

Specifically, the processor 206 may generate a preliminary driving time of the destination using the estimator. The preliminary driving time may be the time expected to drive to a destination that passes by a simple light without staying in a stopover. The processor 206 may generate, by the navigation application, preliminary driving trajectory data based on an expected traffic condition of at least one of a time at the time of the route request and an expected stopover time of the stopover. The estimator may output the preliminary driving time of the destination with reference to the preliminary driving trajectory data.

The processor 206 may then use the combiner to sum the preliminary driving time of the destination and the estimated stay time of the stopover to estimate the final driving time of the target. The processor 206 may generate, by the navigation application, final driving trajectory data based on the traffic condition expected at a time after the stay time that is not the expected stopover time of the stopover. The final driving trajectory data reflecting the stay time may be different from the driving trajectory data of the destination that does not reflect the stay time. Further, the final driving time may be generated with reference to the final driving trajectory data.

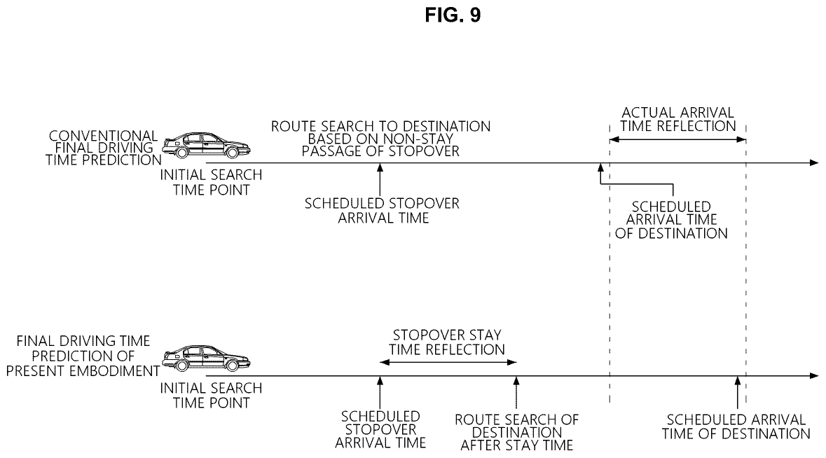

FIG. 9 is a diagram comparing the estimation of the driving time according to the conventional method and the present embodiment.

The conventional route guidance provides the route of the destination and the scheduled arrival time on the assumption that the driver simply passes through the stopover without staying at the stopover, so that the driver who actually goes to the destination after staying may not accurately determine the final scheduled arrival time. According to the conventional route guidance, inconvenience is caused in that a user re-searches a route by estimating a stay time in a route request of a destination. In addition, since the conventional route guidance does not reflect the traffic condition after the stay time, it may present an inappropriate route with a traffic jam.

According to this embodiment. since stay times of different stops are estimated according to characteristics and tendencies of a user who has boarded the vehicle, an estimated arrival time of a destination may reflect a personalized estimated stay time. Further, a route of the destination based on the expected traffic condition after the stay time may be provided to the user. Accordingly, the estimated arrival time of the destination may be customized and more accurate. The route to the destination may also be more suitably guided to the user.

According to the present disclosure, it is possible to provide a method and apparatus for estimating driving time that accurately predicts the estimated arrival time at a destination in route guidance including a stopover.

Specifically, since the stay time at a stopover varies depending on the preferences of the vehicle user, the convenience of using navigation can be enhanced by providing the arrival time at the final destination based on the stay time at the stopover estimated according to the user's preferences.

Effects obtained in the present disclosure are not limited to the above-mentioned effects, and other effects not mentioned above may be clearly understood by those skilled in the art from the following description.

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure, and the matters described in the various embodiments may be applied independently or in combination of two or more.

In addition, various embodiments of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

What is claimed is:

1. A method for estimating a driving time on a stopover route, the method comprising:
providing a memory configured to store at least one instruction and a processor configured to execute the at least one instruction stored in the memory;
predicting, by the processor, an estimated arrival time of a stopover, in response to a route request of a vehicle including the stopover;
estimating, by the processor, a stay time of the stopover based on user information of the vehicle and scheduled use information of the stopover; and
predicting, by the processor, a final driving time to a destination based on the estimated stay time.

2. The method of claim 1, wherein the user information comprises user attribute data and driving data, the user attribute data includes at least one of an age and a gender of the user, and the driving data includes a distance to the stopover.

3. The method of claim 1, wherein the scheduled use information comprises stopover data, an estimated time zone in which the stopover is used, and a date characteristic associated with a use date of the stopover, the stopover data includes an identifier of the stopover, a type of the stopover, and operation data of the stopover, and the estimated time zone is determined based on the estimated arrival time.

4. The method of claim 3, wherein the date characteristic is defined as any one of weekdays, weekends, and holidays.

5. The method of claim 1, wherein the estimating a stay time of the stopover comprises estimating the stay time using a deep learning-based stay time estimation model.

6. The method of claim 5, wherein the stay time estimation model uses a convolutional neural network-based autoencoder model.

7. The method of claim 5, wherein the estimated stay time is an average stay time according to analysis of the user information and the scheduled use information.

8. The method of claim 5, wherein the estimated stay time is generated to be equal to or longer than a minimum stay time according to the analysis of the user information and the scheduled use information.

9. The method of claim 5, wherein the stay time used for learning of the stay time estimation model is generated based on time data of previous driving trajectory data of visiting the stopover, and the time data includes an arrival time of the stopover and a departure time of the stopover.

10. The method of claim 5, wherein the stay time used for learning of the stay time estimation model uses a stopover stay time accumulated with the previous stopover use, and is generated as a weighted average of the accumulated stopover stay time, and the weighted average gives a lower weight to a stopover stay time collected relatively in the past.

11. An electronic device comprising:
a communication unit for transmitting and receiving data to and from the external device;
a memory configured to store at least one instruction; and
a processor configured to execute the at least one instruction stored in the memory, wherein the processor is configured to:
predict an estimated arrival time of a stopover, in response to a route request of a vehicle including the stopover;
estimate a stay time of the stopover based on user information of the vehicle and scheduled use information of the stopover; and
predict a final driving time to a destination based on the estimated stay time.

12. The electronic device of claim 11, wherein the user information comprises user attribute data and driving data, the user attribute data includes at least one of an age and a gender of the user, and the driving data includes a distance to the stopover.

13. The electronic device of claim 11, wherein the scheduled use information comprises stopover data, an estimated time zone in which the stopover is used, and a date characteristic associated with a use date of the stopover, the stopover data includes an identifier of the stopover, a type of the stopover, and operation data of the stopover, and the estimated time zone is determined based on the estimated arrival time.

14. The electronic device of claim 13, wherein the date characteristic is defined as any one of weekdays, weekends, and holidays.

15. The electronic device of claim 11, wherein the estimation of a stay time of the stopover comprises estimating the stay time using a deep learning-based stay time estimation model.

16. The electronic device of claim 15, wherein the stay time estimation model uses a convolutional neural network-based autoencoder model.

17. The electronic device of claim 15, wherein the estimated stay time is an average stay time, or is equal to or longer than a minimum stay time, according to analysis of the user information and the scheduled use information.

18. The electronic device of claim 15, wherein the stay time used for learning of the stay time estimation model is generated based on time data of previous driving trajectory data of visiting the stopover, and the time data includes an arrival time of the stopover and a departure time of the stopover.

19. The electronic device of claim 15, wherein the stay time used for learning of the stay time estimation model uses a stopover stay time accumulated with the previous stopover use, and is generated as a weighted average of the accumulated stopover stay time, and the weighted average gives a lower weight to a stopover stay time collected relatively in the past.

20. A non-transitory computer readable medium containing program instructions executed by a processor, the computer readable medium comprising:
program instructions that predict an estimated arrival time of a stopover, in response to a route request of a vehicle including the stopover;
program instructions that estimate a stay time of the stopover based on user information of the vehicle and scheduled use information of the stop; and
program instructions that predict a final driving time to a destination based on the estimated stay time.
